(19) United States
(12) Patent Application Publication
(10) Pub. No.: US 2014/0282654 A1
(43) Pub. Date: Sep. 18, 2014

(54) Method of Metering Video Playback

(71) Applicant: R. R. Donnelley & Sons Company, Chicago, IL (US)

(72) Inventors: Michael Wang, Brooklyn, NY (US); Noah Sussman, New York, NY (US)

(21) Appl. No.: 13/841,171

(22) Filed: Mar. 15, 2013

(51) Int. Cl. H04N 21/254; H04N 21/262; H04N 21/266; H04N 21/442

(52) U.S. Cl. CPC H04N 21/2541; H04N 21/44204; H04N 21/26233; H04N 21/266
USPC 725/14

(57) ABSTRACT

A method of metering playback of videos in a video library includes sending a message to continue playback of a video and determining whether a playback amount of time has been exhausted. The method includes the further step of sending a message to interrupt playback of the video if the playback amount has been exhausted.

### BACKGROUND OF THE INVENTION

1. Field of the Invention

The present application is generally directed to video playback, and more particularly to metering how long a user may playback one or more videos.

2. Description of the Background of the Invention

Videos presented over the Internet are generally available to all users or only to subscribers. In some cases, to gain a subscriber, a video provider may allow a user access to a limited portion of a library available from the provider. In such cases, the user cannot access the remainder of the library without registering or subscribing to a service offered by the provider. The provider requires the user to decide to subscribe to the services offered thereby based on the limited portion of the library selected by the provider. This scheme may leave behind potential subscribers who may have an interest in videos in the library but are not aware of such videos because such potential subscribers do not have access to the entire breadth of the library.

In other cases, the video provider may allow a user access to small portions (or trailers) of the videos in the library. However, such trailers have to be created separately from the full-length videos in the library and increase the costs incurred by the video provider. Once again, such costs may make it prohibitive for the video provider to provide a potential subscriber access to the entire breadth of the library.

An e-commerce platform that offers flexible metered access to videos in video may encourage users to subscribe to video services.

### SUMMARY OF THE INVENTION

According to one aspect of the present invention, a method of metering playback of videos in a video library includes steps of sending a message to continue playback of a video and determining whether a playback amount of time has been exhausted. The method includes the further step of sending a message to interrupt playback of the video if the playback amount has been exhausted.

### BRIEF DESCRIPTION OF THE DRAWINGS

FIG. 1 is a block diagram of a system for metering video playback;

FIG. 2, is a flowchart of processing undertaken by client computer of the system of FIG. 1; and

FIGS. 3-5 are flowcharts of processing undertaken by a metering server of the system of FIG. 1.

### DETAILED DESCRIPTION OF THE PREFERRED EMBODIMENTS

Referring to FIG. 1, a system 100 for metering videos provided to subscribers includes a metering server 102 and a database 104. A user accesses a web page hosted on a web server 106 to view a video on a client computer 110 operated by the user. One or more videos 108 associated with the web server 106 are stored in a video library 108. Communications between the metering server 102, the web server 106, and the client computer 110 may be undertaken using any type of network including a wide area network such as the Internet, a cellular network, a local area network, and the like, FIG. 1 depicts three client computers 110 communicating with the metering server 102. It should be apparent that more or fewer client computers 110 may communicate with the metering server 102 concurrently. Further the client computer 110 may be any type of computing device including a portable or desktop computer, a smart phone, a tablet, and the like. In some embodiments, the videos of the video library 108 may be stored on a computer separate from the web server 106. In such cases, the web server 106 may provide a hyperlink to the browser operating on the computer 110 to the video in the video library 108 and a video player operating on the client computer 110 may access the video in accordance with such hyperlink.

To view a video, the user uses, for example, a browser operating the client computer 110 to access a web page generated by the web server 106. The web page allows the user to select a video in the video library 108 to view. In response, the web server 106 generates a further web page displayed on the client computer 110 that includes a video player loaded with the video to be displayed. For metered videos, the web page generated by the web server 106 may be provided with a metering client 112 that also operates on the client computer 110. Typically, the video selected by the user begins playing once the web page is loaded. Thereafter, the metering client 112 sends a message to the metering server 102 that indicates the selected video has started playing. The metering server 102 determines the privileges associated with the client computer 110 (or the user operating such computer), and sends a message to the metering client 112 that indicates whether the video playback should be enabled. In some embodiments, the video playback is enabled if the user subscribes to a service that provides access to the videos in the library. In some embodiments, the videos in the video library 108 may be classified into one or more tiers or zones. Such tiers may be associated with particular videos in the video library 108 and the user may have privileges to access some tiers but not others. Videos in the video library 108 may be categorized into tiers based on release date, popularity, producer of the video, topic of the video, delivery format of a video such as high-definition, 3-dimensional, and the like.

Further, a user may be provided access that allows the user to playback any video in the video library 108 or a tier of videos as long as the cumulative playback time of such videos does not exceed a predetermined playback amount of time associated with the user. For example, the user may be allowed predetermined amount of playback time for a particular tier (or the entire video library 108) and the user may view any video within such tier (or the entire library) until the predetermined amount of time has been exhausted. The user can decide to view one video for the entire predetermined amount of time. Alternatively, the user can view a plurality of videos, wherein the cumulative playback time of such plurality of videos does not exceed the predetermined amount of time. Such predetermined amount of time may be provided to the user once or may be refreshed periodically (e.g. at the beginning of each month).

In some embodiments, the playback time may allow the user unlimited access to one or videos in the video library 108 for a period time (e.g., one month). In some embodiments, rather than an amount of time, the playback time may allow the user to access a particular number of videos during a period of time. The number of videos allowed may be refreshed periodically (e.g., at the beginning of each month).

If the metering server 102 determines that the user is allowed access to the video and that such user has not exhausted the permitted playback time associated with that user, the metering server 102 notifies the metering client 112 to enable playback of the video. Typically, the response from the metering server 102 is simply an acknowledgement of the message sent by the metering client 112. Otherwise, the metering server 102 notifies the metering client 112 that the video playback should be interrupted and a promotion should be displayed to the user. Such promotion may notify the user that the playback time has expired and allow the user to subscribe in order to continue to watch the video. If the user subscribes, video playback is continued. Otherwise, the video playback remains stopped. In some embodiments, if the user declines a subscription, the metering client 112 redirects the browser to load a different web page.

In some embodiments, the metering server 102 may direct the metering client 112 to interrupt video playback and display one or more promotions at intervals before the playback time is completely exhausted. For example, a promotion may be displayed 10 minutes, 5 minutes, and 1 minute before the playback time is exhausted. Typically, these promotions are in addition to the promotion that is displayed when the playback time is exhausted. If the user subscribes in response to the display of any of these promotions, further promotions are not displayed.

In some embodiments, if metering client 112 receives the message that video playback should not be enabled, the metering client 112 displays in the browser operating on the client computer 110 a promotion that offers to the user an opportunity to subscribe to a service or a tier of service that would allow the video to be displayed.

If the metering client 112 receives the message that the video playback should be enabled, the user may be allowed to use a video player operating on the client computer 110 to begin playing the video. At predetermined intervals, the metering client 112 communicates with the video player to determine if the video is still playing. If the video is still playing, the metering client 112 notifies the metering server 102 and requests authorization from the metering server 102 to continue playback of the video. If the metering server 102 determines that the playback time allocated to the user has not been exhausted, the metering server 102 sends a response to the metering client 112 that video playback should continue.

Otherwise, the metering server 102 sends a response to the metering client 112 that the video playback should stop. In response, the metering client 112 directs the video player operating on the client computer 110 to stop playback of the video. In such cases, the metering client 112 may cause the browser to operating on the computer 110 to display the subscription page described above.

FIG. 2 is a flowchart of processing undertaken by the metering client 112 operating on the client computer 110 to meter playback of a video. At a block 200, a browser operating on the client computer 110 downloads and displays a web page that includes a video selected by the user. As noted above, the browser calls up a video player that starts playback of the video. At a block 202, the metering client 112 sends a message to the metering server 102 that the user has selected a video for playback and waits for a response.

Messages sent by the metering client 112 to the metering server 102 may include identifying information about the user and/or the client computer 110, identifying information regarding the video library 108 from the video is to be accessed, and identifying information about the video. In some embodiments, the identifying information may include one or more of a predetermined unique identifier, a title, release date, popularity, producer, format, and the like. Such messages may also include a timestamp.

After the response from the metering server 102 is received at the block 202, the metering client 112, at a block 204, determines whether the response from the metering server 102 indicates that playback of the video is to be interrupted, for example, to display a promotion message. If playback of the video is to be interrupted, the metering client 112 proceeds to a block 206. Otherwise the metering client 112 proceeds to a block 208.

At the block 206, the metering client 112 directs the video player to pause the video and directs the web browser to display a promotion message. In some embodiments, the metering server 102 provides in the response sent thereby HTML code that is loaded into a layer of the browser web page. Such HTML code may include a subscribe button that directs the browser to open a subscription page or a button (such as a close button) that the user may select to decline the offer. In some embodiments, the promotion message is displayed as an overlay over the video player.

After displaying the promotion message, the metering client 112, at a block 210, determines if the response received from the metering server 102 at the block 202 indicated that the video should be stopped if the user does not subscribe. If so, the metering client 112 proceeds to a block 212. Otherwise the metering client 112 proceeds to the metering client proceeds to the block 208. At the block 212, the metering client 112 directs the video player to stop video playback and exits.

At the block 208, if the video is already playing the metering client does nothing and proceeds to a block 214. If the video has been paused, for example, by the block 206, the metering client 112 resumes playback of the video and then proceeds to the block 214.

At a block 214, the metering client 112 waits for a predetermined amount of time. In some embodiments, the predetermined amount of time is approximately five seconds. However, it should be apparent that any predetermined amount of time may be used. In some cases, the metering client, at the block 212, sets a timer or an interrupt and pauses. After the predetermined amount of time elapses, the timer or interrupt resumes the metering client 112. Other ways of waiting for a predetermined amount of time will be apparent to those who have skill in the art.

After the predetermined of time elapses, the metering client 112, at a block 216, determines if the video is still playing. If the video has stopped playing, the metering client 112, at a block 218, sends a message to the metering server 102 that the video has stopped and exits.

If at the block 214, the metering client 112 determines that the video is still playing, the metering client 112, at a block 220, sends a message to the metering server 102 requesting whether the video should continue playing and waits for a response (also at the block 220). After receiving the response, processing proceeds to the block 204 to determine if the video should continue playing.

In some embodiments, the metering client 112 receives a message from the video player operating on the client computer 110 whenever video playback is started or stopped. Receipt of such a message from the video player that video playback has started may cause the metering client 112 to immediately proceed to the block 202. Similarly, receipt of a message from the video player that video playback has been stopped (for example, the user pressed a stop control or the video ended), causes the metering client 112 to proceed to the block 216. In some embodiments, the video player notifies the metering 112 when the user uses the rewind or fast-forward controls of the video player. Because such actions cause a pause in the video playback, such actions cause the metering client 112 to immediately proceed to the block 218 to notify the metering server 102 that the video playback has stopped. When video playback is resumed after such an action, the metering client 112 immediately proceeds to the block 202. In such embodiments, the time associated with rewinding and fast-forwarding the video does not count against the total playback time remaining for the user. In other embodiments, the time associated with rewinding or fast-forwarding a video may count against the total playback time remaining for the user.

FIGS. 3-5 illustrates a flowchart of processing undertaken by a metering server 102. At a block 300, the metering server 102 receives a message from a metering client 112. At a block 302 the metering server 102 determines if the message is a video start message. If so, the metering server 102 proceeds to a block 304, otherwise, the metering server 102 proceeds to a block 306.

At the block 304, the metering server 102 queries the database 104 to determine if the user identified in the message is authorized to view the video identified in the message and generates a response. Referring to FIG. 4, at a block 400, the metering server 102 determines if the user is a subscriber to the identified video and if so, at a block 402, the metering server 102 sends a response that the video playback may be enabled and returns to the block 300. As noted above, in some cases such response may simply be an acknowledgement that the message from the metering client 112 was received. In other cases, the response may indicate to the metering client 112 that the user is a subscriber. In some embodiments, the metering client 112 may record the status of the user (for example at the block 202) and not generate any additional messages to the metering server 102 during playback (for example, the messages sent at the block 220).

Otherwise, if the user is not a subscriber to the identified video, then at a block 404, the metering server 102 queries the database 104 to determine if the user has more than a predetermined amount of playback time remaining to view the video. If the user does have more than the predetermined amount playback time remaining, the metering server 102 proceeds to a block 406. Otherwise, the metering server 102 proceeds to a block 408.

At the block 406, the metering server 102 records a timestamp in an entry associated with the user identified in the message. The metering server 102 may record a timestamp reported by the computer on which the metering server 102 is operating, or the timestamp provided in the message from the metering client 112.

At the block 408, the metering server 102 sends generates a response that video playback should be interrupted or stopped. If some playback time remains, the response indicates that video playback should be interrupted. If no playback time remains, the response indicates that video playback should be interrupted and cannot be resumed. In some embodiments, the response identifies another web page to which that the metering client 112 redirects the user. The metering server 102 also generates content of the message to be displayed to the user (e.g., HTML to display a promotion) and includes such content in the response. The metering server 102 transmits the message and returns to the block 300.

Referring once again to FIG. 3, at the block 306, the metering server 102 determines if the message received at the block 300 is a message to determine if playback should continue. If so, the metering server 102 proceeds to a block 308, otherwise the metering server 102 proceeds to a block 310.

At the block 308, the metering server 102 generates a response to notify the metering client 112 whether video playback should continue. In particular, referring to FIG. 5, at a block 500, the metering server 102 determines if the user identified in the received message is a subscriber to the video identified in the received message, and, if so, proceeds to a block 502. Otherwise the metering server 102 proceeds to a block 504.

At the block 502, the metering server 102 sends a response that video playback should continue and returns to the block 300.

At the block 504, the metering server 102 determines how long the video being viewed by the user has been playing. In some embodiments, the metering server 102 determines how long the video has been played by comparing the timestamp recorded at the block 406 and a current time. In other embodiments, the metering server 102 records in the database 104, each message that is received thereby, for example, at the block 300, and determines the duration from analyzing such messages. Other ways of determining how long the video has been playing will be apparent to those who have skill in the art.

At a block 506, the metering server 102, subtracts the amount of time the video has been playing from the time available to the user for playback and if the result is greater than a predetermined amount of time, proceeds to the block 502. Otherwise, the metering server 102, at a block 508, sends a response that playback should be interrupted or stopped as described above with respect to the block 408, and returns to the block 300.

Referring once again to FIG. 3, at the block 310, the metering server 102 determines if the message received at the block 300 is a video stopped message. If so, the metering server 102 proceeds to a block 312, otherwise the metering server 102 proceeds to a block 314. At the block 312, the metering server 102 records the video stop time in the database entry associated with the user in the database 104 and updates the amount of time available to the user for playback, and returns to the block 300.

At the block 314, the metering server 102 records in a log that an unidentified message was received. Such recordation may be used later to diagnose messaging issues between a metering client 112 and the metering server 102.

It should be apparent to those of skill in the art that the metering client 112 may be implemented using JavaScript functions provided to the client computer 110 by the web server 106. In some embodiments, the metering client 112 may be a browser or video player plug in, as those who have skill in the art would appreciate. In other embodiments, the metering client 112 may be an application program or an embedded application. Other ways of implementing the metering client 112 will be apparent to those who have skill in the art.

The metering server 102 may be an application program that operates alongside a web-serving program such as Apache, IIS, or the like. In some embodiments, the metering server 102 may be an extension such a web-serving program as would be known to one who has skill in the art. In still other embodiments, the metering server 102 may be a standalone application or daemon that operates on a computer.

In some embodiments, communications between the metering client 112 and the metering server 102 is undertaken using the HTTP protocol. In other embodiments, such communication may be undertaken using a remote processing protocol such as SOAP, and the like. Data exchanged between metering client 112 and the metering 102 may be encoded using an encoding protocol such as JSON and the like. Further, such data may be transmitted using a secure protocol such as SSL.

It will be understood and appreciated that one or more of the components, processes, sub-processes, and process steps described in connection with FIGS. 1-5 may be performed by hardware, software, or a combination of hardware and software on one or more electronic or digitally-controlled devices. The software may reside in a software memory (not shown) in a suitable electronic processing component or system such as, for example, one or more of the functional systems, controllers, devices, components, modules, or sub-modules schematically depicted in FIGS. 1-5. The software memory may include an ordered listing of executable instructions for implementing logical functions (that is, “logic” that may be implemented in digital form such as digital circuitry or source code, or in analog form such as analog source such as an analog electrical, sound, or video signal). The instructions may be executed within a processing module or controller (e.g., the metering server 102, the metering client 112, etc.), which includes, for example, one or more microprocessors, general purpose processors, combinations of processors, digital signal processors (DSPs), field programmable gate arrays (FPGAs), or application-specific integrated circuits (ASICs). Further, the schematic diagrams describe a logical division of functions having physical (hardware and/or software) implementations that are not limited by architecture or the physical layout of the functions. The example systems described in this application may be implemented in a variety of configurations and operate as hardware/software components in a single hardware/software unit, or in separate hardware/software units.

The executable instructions may be implemented as a computer program product having instructions stored therein which, when executed by a processing module of an electronic system, direct the electronic system to carry out the instructions. The computer program product may be selectively embodied in any non-transitory computer-readable storage medium for use by or in connection with an instruction execution system, apparatus, or device, such as a electronic computer-based system, processor-containing system, or other system that may selectively fetch the instructions from the instruction execution system, apparatus, or device and execute the instructions. In the context of this document, computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access, i.e., volatile, memory (electronic); a read-only memory (electronic); an erasable programmable read only memory such as, for example, Flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program can be electronically captured via, for instance, optical scanning of the paper or other medium, then compiled, interpreted, or otherwise processed in a suitable manner if necessary, and then stored in a computer memory or machine memory.

It will also be understood that receiving and transmitting of signals as used in this document means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

### INDUSTRIAL APPLICABILITY

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

1. A method of metering video playback, comprising the steps of:
developing a first duration value that corresponds to how long at least a first video of a plurality of videos has been played;
receiving an indication of a start or continuation of playback of a second video of the plurality of videos different from the first video;
developing a second duration value that corresponds to how long the second video has been played; and
allowing playback of the second video if the sum of the first duration value and the second duration value does not exceed a predetermined playback time.

2. The method of claim 1, comprising the further step of transmitting a message that includes a directive to interrupt playback of the second video if the sum of the first duration value and the second duration value exceeds the predetermined playback time.

3. The method of claim 2, wherein the message that includes the directive to interrupt playback includes a directive to display a promotion.

4. The method of claim 3, wherein the message includes computer executable code to render the promotion on a display.

5. The method of claim 1, wherein the plurality of videos comprises a first video library and the predetermined playback time is associated with the first video library.

6. The method of claim 5, further comprising:
receiving an indication of a start or continuation of playback of a third video, wherein the third video is selected from a second video library;
developing a third duration value that corresponds to how long the third video has been played; and
allowing playback of the third video if the third duration value is less than a further predetermined playback time, wherein the further predetermined playback time is associated with the second video library.

7. The method of claim 1, further comprising resetting the predetermined playback time on a periodic basis.

8. The method of claim 1, wherein the first duration value represents the sum of duration values that correspond to how long at least a portion of each of the plurality of videos has been played.

9. A system for metering video playback, comprising:
means for developing a first duration value that corresponds to how long at least a first video of a plurality of videos has been played;
means for receiving an indication of a start or continuation of playback of a second video from the plurality of videos different than the first video;
means for developing a second duration value that corresponds to how long the second video has been played; and
means for allowing playback of the second video if the sum of the first duration value and the second duration value does not exceed a predetermined playback time.

10. The system of claim 9, comprising further means for transmitting a message that includes a directive to interrupt playback of the second video if the sum of the first duration value and the second duration value exceeds the predetermined playback time.

11. The system of claim 10, wherein the message that includes the directive to interrupt playback includes a directive to display a promotion.

12. The system of claim 11, wherein the message includes computer executable code to render the promotion on a display.

13. The system of claim 9, wherein the plurality of videos comprises a first video library and the predetermined playback time is associated with the first video library.

14. The system of claim 13, further comprising:
means for receiving an indication of a start or playback of a third video, wherein the third video is selected from a second video library;
means for developing a third duration value that corresponds to how long the third video has been playing; and
means for allowing playback of the third video if the third duration value is less than a further predetermined playback time, wherein the further predetermined playback time is associated with the second video library.

15. The system of claim 9, further comprising means for resetting the predefined playback time on a periodic basis.

16. The system of claim 9, wherein the first duration value corresponds to a sum of durations of how long at least a portion of each of the plurality of videos has been played.

17. A system for metered playback of videos, comprising:
a metering server;
a client coupled to a display, wherein the client:
plays at least a portion of a first video,
receives a selection of a second video, wherein the second video is different than the first video,
periodically determines if playback of the second video should continue; and
wherein the metering server allows the client to play the second video if a total amount of time the first video and the second video have been played is less than a predetermined playback time.

18. The system of claim 17, wherein the metering server directs the client to interrupt playing the second video if the total amount of time the first video and second video have been played exceeds the predetermined playback time.

19. The system of claim 18, wherein the metering server directs the client to present a promotion on the display.

20. The system of claim 19, wherein the metering server transmits to the client computer executable code to render the promotion on the display.

21. The system of claim 17, wherein the first video and the second video are selected from a first video library and the predetermined playback time is associated with the first video library.

22. The system of claim 21, wherein the metering server allows the client to play a third video selected from a second video library if the total amount of time the videos from the second video library have been played does not exceed a second predetermined playback time.

23. The system of claim 17, further comprising means for resetting the predetermined playback time on a periodic basis.

24. A method for metered playback of videos, comprising the steps of:
displaying on a display at least a portion of a first video of a plurality of videos;
receiving a selection of a second video from the plurality of videos; and
allowing playback of the selected second video until a total amount of time the plurality of videos has been played exceeds a predetermined playback time.

25. The method of claim 24, comprising the further step of interrupting playback of the second video if the total amount of time the plurality of videos has been played exceeds the predetermined playback time.

26. The method of claim 25, wherein the step of interrupting playback includes the step of displaying a promotion on the display.

27. The method of claim 24, wherein the first video and the second video are selected from a first video library and the predetermined playback time is associated with the first video library.

28. The method of claim 27, comprising the further step of allowing playback of a third video selected from a second video library if the total amount of time the videos from the second video library have been played back does not exceed a second predetermined playback time.

29. The method of claim 24, further comprising the step of resetting the predetermined playback time on a periodic basis.

30. A system for metered playback of videos, comprising:
means for displaying on a display at least a portion of a first video of a plurality of videos;
means for receiving a selection of a second video from the plurality of videos; and
means for allowing playback of the selected second video until a total amount of time the plurality of videos has been played exceeds a predetermined playback time.

31. The system of claim 30, comprising further means for interrupting playback of the second video if the total amount of time the plurality of videos has been played exceeds the predetermined playback time.

32. The system of claim 31, wherein the means for interrupting playback includes means for displaying a promotion on the display.

33. The system of claim 30, wherein the first video and the second video are selected from a first video library and the predetermined playback time is associated with the first video library.

34. The system of claim 33, comprising further means for allowing playback of a third video selected from a second video library if the total amount of time the videos from the second video library have been played back does not exceed a second predetermined playback time.

35. The method of claim 30, further comprising means for resetting the predetermined playback on a periodic basis.
